(19) United States
(12) Patent Application Publication
(10) Pub. No.: US 2021/0091447 A1
(43) Pub. Date: Mar. 25, 2021

(54) MICROWAVE CIRCULATOR/ISOLATOR

(71) Applicant: Shenzhen Huayang Technology Development Co., Ltd., Shenzhen (CN)

(72) Inventors: Fei XIONG, Shenzhen (CN); Wei ZHANG, Shenzhen (CN); Huanhuan GUO, Shenzhen (CN); Zongwei TANG, Shenzhen (CN); Jing NI, Shenzhen (CN); Junpeng WANG, Shenzhen (CN); Yuanyong XU, Shenzhen (CN)

(21) Appl. No.: 16/619,259

(22) PCT Filed: Mar. 18, 2019
(86) PCT No.: PCT/CN2019/078441

§ 371 Date: Dec. 4, 2019

(30) Foreign Application Priority Data
Jan. 14, 2019 (CN) 201920064989.0

(51) Int. Cl. H01P 1/387; H01P 1/36

(52) U.S. Cl. CPC H01P 1/387; H01P 1/36

(57) ABSTRACT

A microwave circulator/isolator includes PINs, a shell, and a locating dielectric slice, wherein a laminated assembly is arranged in the shell, notches are formed in the peripheral wall of the shell, and the laminated assembly includes a central conductor electrically connected to the PINs which are fixed to the locating dielectric slice arranged in the shell. The microwave circulator/isolator simplifies the production process, lowers the machining difficulty of the shell, reduces the production cost, and improves the production efficiency.

### TECHNICAL FIELD

The invention relates to communication devices, in particular to a microwave circulator/isolator.

### BACKGROUND

Existing microwave ferrite circulators/isolators comprise a laminated assembly, PIN assemblies, and a hollow shell having an opening formed in the top, wherein the laminated assembly is arranged in the hollow shell; each PIN assembly includes a PIN and a PIN insulator disposed around the PIN; notches are formed in the peripheral wall of the shell, and installation platforms integrated with the shell are arranged at lower parts of the notches; and the PIN assemblies are fixed to the installation platforms and are electrically connected to a central conductor in the laminated assembly. In the actual production process, the PINs are assembled in the PIN insulators, the PIN insulators are assembled on the installation platforms, and one PIN assembly is installed on each installation platform (generally, the microwave ferrite circulators/isolators have three installation platforms which are regarded as the “ears” of the microwave ferrite circulators/isolators), which will undoubtedly affect the production efficiency of the microwave ferrite circulators/isolators.

### SUMMARY

The technical issue to be settled by the invention is to provide a microwave circulator/isolator which has high production efficiency.

The technical solution adopted by the invention to settle the technical issue is as follows: a microwave circulator/isolator comprises PINs, a shell, and a locating dielectric slice, wherein a laminated assembly is arranged in the shell, notches are formed in the peripheral wall of the shell, and the laminated assembly includes a central conductor electrically connected to the PINs which are fixed to the locating dielectric slice arranged in the shell.

Furthermore, the locating dielectric slice includes extension parts which are provided with the PINs and at least partially located in the notches.

Furthermore, the number of the notches is identical to that of the extension parts, and the notches are in one-to-one correspondence with the extension parts.

Furthermore, the number of the notches in the shell is three.

Furthermore, the locating dielectric slice and the PINs are formed through inserts by injection molding.

Furthermore, the locating dielectric slice is located below the central conductor.

Furthermore, an accommodating hole is formed in the locating dielectric slice, and the laminated assembly is partially received in the accommodating hole.

Furthermore, the laminated assembly further includes a lower magnet, a lower uniform magnetic sheet, a lower ferrite, an upper ferrite, an upper uniform magnetic sheet, an upper magnet, a temperature compensation sheet, and a cover plate which are sequentially stacked from bottom to top, wherein the central conductor is clamped between the lower ferrite and the upper ferrite, and at least one part of at least one of the lower ferrite, the lower uniform magnetic sheet, and the lower ferrite is located in the accommodating hole.

Furthermore, the external peripheral wall of the locating dielectric slice is attached to the internal wall of an internal cavity of the shell.

Furthermore, the locating dielectric slice is made from polyphenylene sulfide or similar materials.

The invention has the following beneficial effects: different from traditional microwave circulators/isolators, the novel microwave circulator/isolator does not adopt PIN insulators, so that production steps of the microwave circulator/isolator are reduced, and the production efficiency is improved. Besides, it is unnecessary to configure installation platforms on the shell of the novel microwave circulator/isolator, so that the requirement for machining precision of the shell is lowered, the production efficiency is further improved, and the cost is reduced.

### BRIEF DESCRIPTION OF DRAWINGS

FIG. 1 is an exploded view of a microwave circulator/isolator in Embodiment 1 of the invention.

### REFERENCE SIGNS

1, PIN;

2, shell;

3, notch;

4, locating dielectric slice;

41, extension part;

42, accommodating hole;

51, lower magnet;

52, lower uniform magnetic sheet;

53, lower ferrite;

54, central conductor;

55, upper ferrite;

56, upper uniform magnetic sheet;

57, upper magnet;

58, temperature compensation sheet;

59, cover plate.

### DETAILED DESCRIPTION OF THE EMBODIMENTS

The technical contents, purposes, and effects of the invention are expounded as follows in combination with the embodiments and accompanying drawings.

The key concept of the invention lies in that: installation platforms are not arranged in notches of a shell any longer, all PINs are fixed to a locating dielectric slice arranged in an internal cavity of the shell, so that workers can assemble the PINs of a microwave circulator/isolator on the shell at a time, thus improving the production efficiency and reducing the cost.

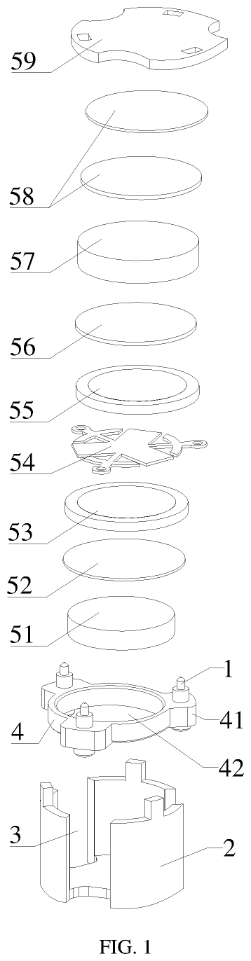

Referring to FIG. 1, a microwave circulator/isolator comprises PINs 1, a shell 2, and a locating dielectric slice 4, wherein a laminated assembly is arranged in the shell 2, notches 3 are formed in the peripheral wall of the shell 2, and the laminated assembly includes a central conductor 54 electrically connected to the PINs 1 which are fixed to the locating dielectric slice 4 arranged in the shell 2.

From the above description, the invention has the following beneficial effects: different from traditional microwave circulators/isolators, the novel microwave circulator/isolator does not adopt PIN insulators, so that production procedures of the microwave circulator/isolator are reduced, and the production efficiency is improved. Besides, it is unnecessary to configure installation platforms on the shell of the novel microwave circulator/isolator, so that the requirement for machining precision of the shell is lowered, the production efficiency is further improved, and the cost is reduced.

Furthermore, the locating dielectric slice 4 includes extension parts 41 which are provided with the PINs 1 and at least partially located in the notches 3.

From the above description, the extension parts can prevent the locating dielectric slice from rotating in the internal cavity of the shell.

Furthermore, the number of the notches 3 is identical to that of the extension parts 41, and the notches 3 are in one-to-one correspondence with the extension parts 41.

Furthermore, the number of the notches 3 in the shell 2 is three.

Furthermore, the locating dielectric slice 4 and the PINs 1 are formed through inserts by injection molding.

From the above description, the locating dielectric slice and the PINs do not need to be manually assembled by workers, so that the production efficiency of the microwave circulator/isolator is further improved.

Furthermore, the locating dielectric slice 4 is located below the central conductor 54.

Furthermore, an accommodating hole 42 is formed in the locating dielectric slice 4, and the laminated assembly is partially received in the accommodating hole 42.

From the above description, the laminated assembly is partially received in the accommodating hole, so that the height of the microwave circulator/isolator is decreased, and the miniaturization of the microwave circulator/isolator is facilitated. Besides, the locating dielectric slice can locate one part of the laminated assembly.

Furthermore, the laminated assembly further includes a lower magnet 51, a lower uniform magnetic sheet 52, a lower ferrite 53, an upper ferrite 55, an upper uniform magnetic sheet 56, an upper magnet 57, a temperature compensation sheet 58, and a cover plate 59 which are sequentially stacked from bottom to top, wherein the central conductor 54 is clamped between the lower ferrite 53 and the upper ferrite 55, and at least one part of at least one of the lower ferrite 53, the lower uniform magnetic sheet 52, and the lower ferrite 53 is located in the accommodating hole 42.

Furthermore, the external peripheral wall of the locating dielectric slice 4 is attached to the internal wall of the internal cavity of the shell 2.

From the above description, the locating dielectric slice will not shift in the horizontal direction in the shell.

Furthermore, the locating dielectric slice 4 is made from polyphenylene sulfide or similar materials.

From the above description, the polyphenylene sulfide (PPS) or similar materials have good heat stability, size stability, chemical resistance, and flame resistance, and can withstand a high temperature of 200° C. for a long time and a high temperature of 280° C. for a short time, thereby meeting the operating requirements of the microwave circulator/isolator.

### Embodiment 1

Referring to FIG. 1, Embodiment 1 of the invention is as follows: a microwave circulator/isolator comprises PINs 1, a shell 2, and a locating dielectric slice 4, wherein a laminated assembly is arranged in the shell 2, notches 3 are formed in the peripheral wall of the shell 2, the laminated assembly includes a central conductor 54 electrically connected to the PINs 1 which are fixed to the locating dielectric slice 4 arranged in the shell 2, and the locating dielectric slice 4 includes extension parts 41 which are provided with the PINs 1 and at least partially located in the notches 3.

The number of the notches 3 is identical to that of the extension parts 41, and the notches 3 are in one-to-one correspondence with the extension parts 41. The number of the notches 3 in the shell 2 is three. In this embodiment, the three notches 3 are uniformly distributed around the central axis of the shell 2, that is, every two adjacent notches 3 are spaced from each other by an angle of 120°.

Preferably, the locating dielectric slice 4 and the PINs 1 are formed through inserts by injection molding. By adoption of such structure, independent pin insertion is not needed anymore during production of the circulator/isolator, so that one procedure is omitted, and the cost is further reduced.

The locating dielectric slice 4 is located below the central conductor 54, namely the locating dielectric slice 4 is located between two parts of the laminated assembly or is located below the laminated assembly.

An accommodating hole 42 is formed in the locating dielectric slice 4, and the laminated assembly is partially received in the accommodating hole 42. In this embodiment, the laminated assembly further includes a lower magnet 51, a lower uniform magnetic sheet 52, a lower ferrite 53, an upper ferrite 55, an upper uniform magnetic sheet 56, an upper magnet 57, a temperature compensation sheet 58, and a cover plate 59 which are sequentially stacked from bottom to top, wherein the central conductor 54 is clamped between the lower ferrite 53 and the upper ferrite 55, and at least one part of at least one of the lower ferrite 53, the lower uniform magnetic sheet 52, and the lower ferrite 53 is located in the accommodating hole 42. Specifically, the accommodating hole 42 is a through hole or a blind hole. Particularly, at least one part of the lower magnet 51 and/or at least one part of the lower uniform magnetic sheet 52 are/is received in the accommodating hole 42, or at least one part of the lower uniform magnetic sheet 52 and/or at least one part of the lower ferrite 53 are/is received in the accommodating hole 42, or at least one part of the lower ferrite 53, at least one part of the lower ferrite 53, and the lower uniform magnetic sheet 52 are received in the accommodating hole 42. Manufacturers selectively adopt the locating dielectric slice 4 to locate a certain part as actually needed. For instance, in this embodiment, the accommodating hole 42 in the locating dielectric slice 4 is adopted to locate the lower magnet 51.

In this embodiment, the lower ferrite 53 and the upper ferrite 55 are respectively peripherally sleeved with ceramic dielectric rings.

The external peripheral wall of the locating dielectric slice 4 is attached to the internal wall of an internal cavity of the shell 2. In this embodiment, the internal cavity of the shell 2 and the locating dielectric slice 4 are cylindrical and have identical sectional areas.

Preferably, the locating dielectric slice 4 is made from polyphenylene sulfide, and compared with polytetrafluoroethylene, the polyphenylene sulfide has higher tolerance and hardness, is not prone to deformation, and can be processed conveniently.

The microwave circulator/isolator in this embodiment effectively lowers the machining difficulty of the shell 2, reduces the assembly procedures of the circulator, and has good size stability and uniformity, thereby improving the production efficiency, reducing the cost, and having high reliability.

In conclusion, the microwave circulator/isolator provided by the invention simplifies the production process, lowers the machining difficulty of the shell, reduces the production cost, and improves the production efficiency.

The above embodiments are only illustrative ones of the invention, and are not intended to limit the patent scope of the invention. All equivalent transformations obtained on the basis of the contents in the specification and the accompanying drawings of the invention, or direct or indirect applications to related technical fields should also fall within the patent protection scope of the invention.

What is claimed is:

1. A microwave circulator/isolator, comprising PINs, a shell, and a locating dielectric slice, wherein a laminated assembly is arranged in the shell, notches are formed in a peripheral wall of the shell, and the laminated assembly includes a central conductor electrically connected to the PINs which are fixed to the locating dielectric slice arranged in the shell.

2. The microwave circulator/isolator according to claim 1, wherein the locating dielectric slice includes extension parts which are provided with the PINs and at least partially located in the notches.

3. The microwave circulator/isolator according to claim 2, wherein the number of the notches is identical to that of the extension parts, and the notches are in one-to-one correspondence with the extension parts.

4. The microwave circulator/isolator according to claim 2, wherein the number of the notches in the shell is three.

5. The microwave circulator/isolator according to claim 1, wherein the locating dielectric slice and the PINs are formed through inserts by injection molding.

6. The microwave circulator/isolator according to claim 1, wherein the locating dielectric slice is located below the central conductor.

7. The microwave circulator/isolator according to claim 1, wherein an accommodating hole is formed in the locating dielectric slice, and the laminated assembly is partially received in the accommodating hole.

8. The microwave circulator/isolator according to claim 7, wherein the laminated assembly further includes a lower magnet, a lower uniform magnetic sheet, a lower ferrite, an upper ferrite, an upper uniform magnetic sheet, an upper magnet, a temperature compensation sheet, and a cover plate which are sequentially stacked from bottom to top, wherein the central conductor is clamped between the lower ferrite and the upper ferrite, and at least one part of at least one of the lower ferrite, the lower uniform magnetic sheet, and the lower ferrite is located in the accommodating hole.

9. The microwave circulator/isolator according to claim 1, wherein an external peripheral wall of the locating dielectric slice is attached to an internal wall of an internal cavity of the shell.

10. The microwave circulator/isolator according to claim 1, wherein the locating dielectric slice is made from polyphenylene sulfide.
